(19) United States
(12) Patent Application Publication
(10) Pub. No.: US 2006/0142544 A1
(43) Pub. Date: Jun. 29, 2006

(54) Polymeric etheramines, their production and use

(76) Inventors: John Martin Farrar, Yorkshire (GB); Benjamin M. Halmshaw, Yorkshire (GB)

Correspondence Address: CLARIANT CORPORATION;INTELLECTUAL PROPERTY DEPARTMENT, 4000 MONROE ROAD, CHARLOTTE, NC, 28205, US

(21) Appl. No.: 10/542,527

(22) PCT Filed: Jan. 15, 2004
(86) PCT No.: PCT/IB04/00123

§ 371 Date: Jul. 15, 2005

(30) Foreign Application Priority Data
Jan. 17, 2003 (GB) 0301094.9
Nov. 6, 2003 (GB) 0325916.5

(51) Int. Cl. C08G 65/04; D21H 23/00

(52) U.S. Cl. 528/421; 162/164.6; 162/164.3

(57) ABSTRACT

Polymeric etheramines (P) obtainable by reaction of (A) an oligohydroxycompound which is an oligohydroxyalkane of molecular weight ≧92 and with x hydroxygroups, wherein x is a number in the range of 3 to 6, or a mixture of two or more thereof, or a mixture of one or more thereof with at least one alkanediol containing 2 to 4 carbon atoms, with (B) epichlorohydrin, in the ratio of more than two moles of (B) per mole of (A) and on average not more than 1.2 molecules of (B) per hydroxygroup of (A), to give a chloro-terminated adduct (E), and exhaustive reaction of (E) with (C) at least one aliphatic oligoamine containing at least one primary amino group and at least one further amino group which is primary or secondary, in the molar ratio of n moles of (C) for every mole of (E), wherein n>1 and smaller than the number of linked chlorine atoms in (E) present on average per molecule of (E), and optionally (D) at least one aliphatic mono- or diamine containing only one primary or secondary amino group any further amino group being tertiary, in the molar ratio of p moles of (D) for every mole of (E), wherein p is sufficient for reacting any available chlorine of (E) not reacted with (C), and in such a ratio of [(C)+(D)] to (E) that the total number t of basic amino groups in [(C)+(D)] is higher than the total number of linked chlorine atoms in (E), and which are optionally protonated, and aqueous compositions thereof, their production and their use as multifunctional adjuvants in the processing of cellulosic fibres in aqueous medium, especially as flocculants, drainage or retention assistants, dye fixatives and trash quenchers in paper and tissue production.

In papermaking, in the wet end the speed and quality of paper production and also the quality of the resulting backwater may be improved by employing suitable adjuvants, drainage or retention aids or also fixatives; typically such adjuvants mostly are polycationic products.

In WO-A-99/67463 there are described certain polycationic, polyquaternary products obtainable by reaction of an oligohydroxyalkane with epichlorohydrin to a chloroterminated adduct and quaternizing, optionally cross-linking reaction with at least one aliphatic secondary monoamine or tertiary oligoamine to the corresponding polyquaternary polymer containing quaternary ammonium groups. These polycationic, polyquaternary products are described as adjuvants in papermaking, in particular as fixatives (“trash quenchers”) in the production of paper from pulp containing coated broke.

In U.S. Pat. No. 3,753,931 there are described certain polyetheramines which are reaction products of aliphatic polyamines with certain polyepihalogenohydrins i.e. polyethers containing poly-(chloro-methyl-ethylenoxy) chains with 3 to 25 chloromethyl-ethylenoxy units in each chain—which polyethers, according to one of the described variants, may be derived from C₁₋₆-alcohols with 1 to 6 hydroxyl groups as starters for the polymerisation of epihalogenohydrin, and in which the excess amine, which is used in large excess over the quantity required for the synthesis, must then be eliminated by distillation—and then reaction with a crosslinking agent. These polyetheramines are described as drainage and retention aids in paper manufacture.

In the production of dyed paper the employed dyes and dyeing conditions do not always allow a satisfactory fixation and colour yield, and if an adjuvant is employed, care has to be taken that it does not interfere with the action of any other adjuvant employed in the wet end. It is thus desirable to provide a product that is compatible with other adjuvants possibly employed and/or that joins several properties in one product or in a group of compatible related products.

It has now been found that the below defined polymeric etheramines (P)—which may be produced in the form of readily dilutable aqueous compositions in a very simple way, without the need of excess amounts of any reactants that would then have to be eliminated—are suitable not only as excellent drainage and retention aids or trash quenchers in paper manufacture, but are suitable as overall cationic adjuvants in the processing of cellulosic fibres, especially in papermaking, mainly in the wet end, and are in particular also useful as outstanding dyeing assistants for improving fixation of dyes in the production of dyed paper.

The invention relates to the polycationic polymers (P) defined below, their production and use, and aqueous compositions thereof

The invention thus firstly provides a polymeric etheramine (P) obtainable by reaction of

(A) an oligohydroxycompound which is an oligohydroxyalkane of molecular weight ≧92 and with x hydroxygroups, wherein x is a number in the range of 3 to 6,
or a mixture of two or more thereof,
or a mixture of one or more thereof with at least one alkanediol containing 2 to 4 carbon atoms,
   with

(B) epichlorohydrin,
in the ratio of more than two moles of (B) per mole of (A) and on average not more than 1.2 molecules of (B) per hydroxygroup of (A),

to give a chloro-terminated adduct (E),

and exhaustive reaction of (E) with

(C) at least one aliphatic oligoamine containing at least one primary amino group and at least one further amino group which is primary or secondary,
in the molar ratio of a moles of (C) for every mole of (E), wherein n>1 and and smaller than the number of linked chlorine atoms in (E) present on average per molecule of (E),
   and optionally

(D) at least one aliphatic mono- or diamine containing only one primary or secondary amino group any further amino group being tertiary,
in the molar ratio of p moles of (D) for every mole of (E), wherein p is sufficient for reacting any available chlorine of (E) not reacted with (C),
   in such a ratio of [(C)+(D)] to (E) that the total number t of basic amino groups in [(C)+(D)] is higher than the total number of linked chlorine atoms in (E),
   and which is optionally protonated.

The polymeric products (P) may be produced by addition and condensation reactions conventional per se. In particular, the process for the production of the polymeric optionally protonated etheramines (P) is characterised in that the chloroterminated reaction product (E) of (A) with (B) is reacted in aqueous medium with (C) and optionally (D) and the product is optionally protonated, preferably to a pH<6. The product (P) may thus be obtained in the form of an aqueous composition (W_{P}), and if desired the obtained aqueous composition may be dried.

As oligohydroxyalkanes of molecular weight ≧92 there may be employed known compounds, in particular low molecular oligohydroxyalkanes with 3 to 6 carbon atoms. The C₂₋₄-alkanediols preferably are C₂₋₄-monoalkyleneglycols, more preferably C₂₋₃-monoalkyleneglycols.

Preferably (A) is

(A₁) an oligohydroxyalkane of the formula
X—(OH)ₓ₁ (I),
in which X signifies the x1-valent radical of a C₃₋₆-alkane
and x1 signifies a number from 3 to the number of carbon atoms in X,
or a mixture of oligohydroxyalkanes of formula (I),
or a mixture of one or more oligohydroxyalkanes of formula (I) with a C₂₋₃-alkylene-glycol.

More preferably (A) or (A₁) is

(A₂) an oligohydroxyalkane of formula (I) or a mixture of oligohydroxyalkanes of formula (I),

As oligohydroxyalkanes of formula (I) there may be employed known compounds, e.g. glycerol, threitol, erythritol, pentaerythritol, trimethylol-ethane or -propane and reduction products of conventional carbohydrates with five or six carbon atoms, such as arabinol, xylitol, sorbitol, mannitol and dulcitol.

Preferred compounds of formula (I) are those of formula
H—(CHOH)ₓ₁—H (I′).

The compounds of formula (I′) with four to six carbon atoms may be employed in the form of racemic mixtures or of single optical isomers; they are solid at ambient temperature and are thus expediently employed in admixture with at the least one compound selected from glycerol, ethylene glycol and propylene glycol, which are liquid at ambient temperature. The quantitative ratio of such mixtures is chosen suitably so that the mixture is liquid at the chosen reaction temperature; a mixture of one part by weight of compound with two to three carbon atoms with 1 to 4 parts by weight of compound of formula (I) with four to six carbon atoms already provides a liquid mixture. Preferably in (A) there is employed no C₂₋₄-alkyleneglycol.

According to a preferred feature of the invention as (A) or (A₁) or (A₂) there is employed glycerol or a mixture of glycerol with a compound of formula (I′) in which x1 is 5 or 6. Where there is employed such a mixture of glycerol with a compound of formula (I′) in which x1 is 5 or 6, the weight ratio of glycerol to the other compound may range in a broad scope, e.g. from 0.25:1 to 10:1, preferably 0.5:1 to 5:1, more preferably 0.8:1 to 2:1. Most preferably as (A) or (A₁) or (A₂) there is employed glycerol alone.

Preferably (A) is reacted with (B) in the ratio of m moles of epichlorohydrin (B) for every mole of oligohydroxycompound or mixture (A), in which m is >2 and at most 1.2·x,

The molar ratio m of epichlorohydrin (B) to oligohydroxycompound or mixture (A) or (A₁) or (A₂) is preferably in the range of 2.2 moles to 1.2·x moles, more preferably 2.5 moles to 1.1·x moles, of epichlorohydrin for every mole of oligohydroxycompound or mixture (A) or (A₁) or (A₂).

The reaction of (A) with (B) is preferably carried out in the absence of any other solvent and in the presence of a catalyst, which is e.g. a Lewis acid, preferably boron trifluoride preferably in the form of its etherate or acetic acid complex. This reaction is an addition reaction of the epichlorohydrin to a hydroxy group, with opening of the epoxy ring and formation of a 2-hydroxy-3-chloropropyl-1 radical. This reaction is exothermic and the reaction temperature is preferably kept below 100° C., more preferably in the range of 60 to 85° C., with cooling. The epichlorohydrin reacts with the available hydroxy groups of (A) and, as reaction proceeds, may also react with a hydroxy group of a 2-hydroxy-3-chloropropyl-1 radical formed during the reaction, so that some of the hydroxy groups of (A) or (A₁) or (A₂), e.g. of the compounds of formula (I), may even remain non-reacted with (B). Depending on the molar ratio, on the functionality of the oligohydroxycompound (e.g. the value of x or x1) and on the optical configuration of (A) or (A₁) or (A₂), e.g. of the compounds of formula (I) or (I′)—especially if x1 is 4 to 6—the degree of reaction of the OH groups of (A) with (B) may vary, and may e.g. be in the range of 50 to 95%, mostly 75 to 95%, of the total number of OH groups originally present in (A).

The obtained adduct (E) is a chloro-terminated product. Referred to formula (I) it may be represented by the formula 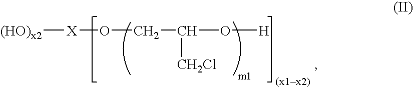
wherein x2 is the number of hydroxygroups linked to X which have not reacted with (B) in favour of a corresponding number of hydroxygroups introduced with (B), and the sum Σm1, which on average corresponds to (x1−x2)·m1, equals m. As may be deduced from the above mentioned degree of reaction of the hydroxygroups of (A) with (B), x2 may range e.g. in the scope of 0 to 0.5·m, mostly in the scope of 0.05·m to 0.25·m. In each of the (x1−x2) radicals of formula 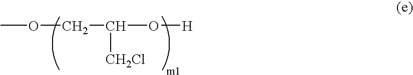
m1 may have the same or different values; mostly m1 signifies 1 or 2.

The so produced adduct (E) is then reacted with (C) preferably in a ratio n which is preferably >1 and <m, and optionally with (D) in the ratio p which is preferably ≧0 and <(m−n).

In the amines (C) and (D) the aliphatic bridging groups between two amino nitrogen atoms are expediently low molecular, preferably with <6 carbon atoms, more particularly with 2 to 6 carbon atoms, and any substituents at the amino nitrogens are expediently also low molecular, preferably with ≦6 carbon atoms, more particularly with 1 to 3 carbon atoms. The aliphatic bridging groups and substituents are preferably saturated.

The definition of (C) as at least one aliphatic oligoamine containing at least one primary amino group and at least one further amino group which is primary or secondary, means as (C) in particular at least one aliphatic oligoamine containing a primary amino group and a further amino group which is primary or secondary, any still further amino groups being secondary,

As amines (C) there may in particular be employed known aliphatic oligoamines with bridging C₂₋₆-alkylene groups, and containing one or two primary amino groups, any further amino groups being secondary. A terminal amino nitrogen may be substituted with an aliphatic substituent that does not interfere with the reaction, preferably with low molecular alkyl or hydroxyalkyl, so long as at least one of the amino groups is a primary amino group and any further amino group is secondary. The oligoamines (C) preferably contain ≦6 amino groups, more preferably 2 to 4 amino groups.

C) preferably is
(C₁) at least one oligoamine of formula

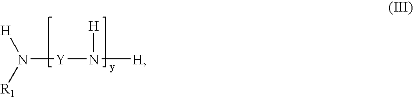

wherein
R₁ signifies hydrogen or C₁₋₃-alkyl,
y signifies a number from 1 to 3

and
Y signifies C₂₋₃-alkylene, if y is 2 to 3,
   or signifies C₂₋₆₋alkylene, if y is 1.

If y=2 to 3, the bridging alkylene Y may be ethylene, propylene-1,2 or propylene-1,3, of which ethylene and propylene-1,3 are preferred, especially ethylene. If y=1, the bridging alkylene Y may be e.g. ethylene, propylene-1,2, propylene-1,3, or tetra- to hexamethylene, of which ethylene, propylene-1,3 and hexamethylene are preferred, in particular propylene-1,3 and especially ethylene. If R₁ signifies C₁₋₃-alkyl it preferably stands for ethyl or methyl, most preferably methyl. The index y preferably signifies a figure in the range from 2 to 3.

As amines (D) there may be employed known aliphatic mono- or diamines in which at least one of the amino nitrogens is substituted with an aliphatic substituent that does not interfere with the reaction, preferably low molecular alkyl or hydroxyalkyl, so long as (D) contains at most one primary or secondary amino group; in the diamines the bridging group preferably is C₂₋₆-alkylene, more preferably C₂₋₃₋alkylene.

(D) preferably is
(D₁) at least one aminocompound of formula

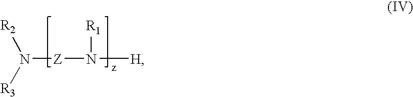

wherein
Z signifies C₂₋₆-alkylene,
z signifies 0 or 1,
R₂ signifies C₁₋₃-alkyl

and
R₃ signifies C₁₋₃-alkyl, if z is 1,
   or signifies hydrogen or C₁₋₃-alkyl, if z is 0.

The bridging alkylene Z may be e.g. ethylene, propylene-1,2, propylene-1,3, or tetra- to hexamethylene, of which ethylene, propylene-1,3 and hexamethylene are preferred, in particular propylene-1,3. The index z preferably signifies 1. R₂ preferably stands for ethyl or methyl, most preferably for methyl. R₃ preferably has the same significance as R₂ and stands for ethyl or methyl, most preferably for methyl.

According to a preferred feature, the invention thus provides polymers (P′) obtainable by reaction of (A₁) with (B), in the ratio of m moles of epichlorohydrin for every mole of compound (A₁), to give a chloro-terminated adduct (E′), and exhaustive reaction of (E′) with (C₁) and optionally with (D₁).

According to a further preferred feature, the invention provides polymers (P″) obtainable by reaction of (A₂) with (B), in the ratio of m moles of epichlorohydrin for every mole of compound (A₂), to give a chloro-terminated adduct (E″), and exhaustive reaction of (E″) with (C₁) and optionally with (D₁).

The process for the production of (P′) is thus characterized in that (A₁) is reacted with (B) in the ratio of m moles of (B) for every mole of compound (A₁) to give a chloro-terminated adduct (E′), and (E′) is exhaustively reacted with (C₁) and optionally (D₁). The process for the production of (P″) is thus characterized in that (A₂) is reacted with (B) in the ratio of m moles of (B) for every mole of compound (A₂) to give a chloro-terminated adduct (E″), and (E″) is exhaustively reacted with (C₁) and optionally (D₁). According to one feature of the process, the reaction conditions are preferably chosen in such a way that (C) or (C₁) is sufficient for complete reaction with all the available terminal chlorine of (E) or (E′) or (E″), and no (D) or (D₁) is required.

Since the reaction of (B) with (A) or respectively (A₁) or (A₂) is practically quantitative, the figure m represents also the number of linked terminal chlorine atoms in (E) or (E′) or (E″). The ratio of (C) and (D) to (E) is suitably chosen in such a range that polymeric products (P) can result and the chlorine atoms of (E) or (E′) or (E″) are exhaustively reacted with (C) and optionally (D). The figure t also indicates the total number of molequivalents of [(C)+(D)] referred to basic amino groups present in the non-protonated form of [(C)+(D)]. Preferably the total number t₁ of molequivalents of [(C)+(D)] referred only to primary and secondary aminogroups present in (C) and (D) is in excess over m.

n preferably is a figure >0.2·m, e.g. a figure in the range of 0.2·m to (m−0.1), preferably 0.4·m to (m−0.2), more preferably 0.4·m to (m−0.5).

p preferably is 0 to 2·n, e.g. 0. If (D) is employed, p preferably is ≧0.25·n, e.g. a figure in the range of 0.25·n to 2·n.

The total number of basic aminogroups—i.e. of primary, any secondary and any tertiary basic amino groups, preferably of primary and any secondary basic amino groups—present in [(C)+(D)] is higher then the total number of chlorine atoms present in (E) or (E′) or (E″), so that the chlorine atoms in (E) or (E′) or (E″) can be exhaustively reacted with (C) and any (D), and t—and preferably also t₁—is >m, preferably >1.2·m, more preferably >1.5·m. Referred to formulae (III) and (IV) in particular n·(y+1)+p·(z+1)>m, preferably >1.2·m, more preferably >1.5·m. More particularly n·(y+1)+p·z>m, preferably >1.2·m, more preferably >1.5·m.

The polymeric products (P) of the invention are polyetheramines and contain the amino groups optionally in protonated form. They may also contain a minor proportion of quaternary ammonium groups, i.e. a number of quaternary ammonium groups that is inferior to the number of optionally protonated amino groups present.

The total number of primary amino groups present in [(C)+(D)] is preferably higher, in particular more than twice, more preferably more than 2.5 times, the total number of tertiary amino groups of diamine (D) present in [(C)+(D)], or of secondary monoamine (D) present in [(C)+(D)], so that either no diamine or secondary monoamine (D) is used and the resulting product is practically exempt of any quaternary ammonium groups, or if any diamine or secondary monoamine (D) is used, and may lead to quaternary ammonium groups, these are present in a minor proportion of the total of quaternary ammonium groups and non-quaternary amino groups present, preferably ≦30% e.g. 2 to 30% of the total of the quaternary ammonium groups and non-quaternary amino groups present, more preferably ≦25% e.g. 3 to 25% of the total number of quaternary ammonium groups and non-quaternary amino groups present. Thus the resulting product is either exempt of any quaternary ammonium groups, or, if any quaternary ammonium groups are present, their number is preferably ≦30%, more preferably ≦25% of the total number of quaternary ammonium groups and non-quaternary amino groups present.

The polymeric product (P) may optionally be crosslinked.

The reaction of (C) and any (D) with (E) is carried out suitably in aqueous medium, e.g. at a water content in the range of 40 to 90%, preferably 50 to 88%, referred to the total weight of the aqueous reaction mixture, and preferably with heating, e.g. at a temperature in the range of 30 to 90° C., preferably 40 to 70° C. During the reaction the basicity of the amines (C) and, if present, also (D) may be sufficient for the alkylation of (C) and respectively (D) with the chloride (E) used as an alkylating agent, if desired there may even be employed a strong base, e.g. potassium hydroxide or preferably sodium hydroxide. The pH of the reaction mixture is preferably in the range of 7 to 10. (D) may be added e.g. simultaneously with (C) or even subsequently to (C). If in the reaction there has been employed a proportion of (C) which alone is insufficient for reacting with all covalently linked chlorine the required amount of compound (D) may be added to complete the reaction of (E). When the reaction has completed or has reached the desired degree, the reaction mixture is suitably acidified by addition of a conventional acid, preferably a mineral acid (such as hydrochloric acid, sulphuric acid or phosphoric acid) or a low molecular aliphatic carboxylic acid e.g. with 1 to 6 carbon atoms (such as formic acid, acetic acid, citric acid or lactic acid), preferably to reach a pH below 6, more preferably in the range of 3.5 to 5.5, most preferably 4 to 4.5. The proceeding of the reaction may be pursued by checking the viscosity of the reaction mixture, which gives an empirical impression of the degree of polymerisation and crosslinking. A suitable viscosity is e.g. ≦5000 cP, preferably in the range of 200 to 3000 cP.

That the reaction of (E) with (C) and any (D) is exhaustive means that there is employed such a quantity of (C) and optionally (D) that the number t of reactive amino groups in (C)+(D) is higher than the number of linked chlorine atoms in (E), and the alkylation and polymerisation reaction is carried out until the polymerised and optionally crosslinked product (P) in the form of its aqueous reaction mixture is stirrable and in its protonated form is dilutable with water. This limit can be assessed e.g. by monitoring the viscosity during polymerisation/crosslinking, as mentioned above.

Depending on the ratios of (C) to (E) and (D) to (E)—in addition to the suitable choice of the reaction conditions—there may be produced polymeric etheramines (P) of a broad range of degrees of polymerisation and of crosslinking and, referred to the protonated form, also of a broad range of cationicities. Their cationicity—which may be assessed e.g. by means of a charge analyser or by other suitable methods—is e.g. in the range of 2 to 10, preferably 3 to 8 meq/g at pH 4.

Preferably there may in particular be produced
(P_{A}) polymeric, crosslinked, protonated etheramines P) in which n is a number in the range of from 0.4·m to 0.72·m, and p<0.25·n,
(P_{B}) polymeric, protonated etheramines (P) in which n is a number in the range of from 0.72·m to (m−0.1), and p<0.25·n, which may be crosslinked.
   and
(P_{C}) polymeric, crosslinked, protonated etheramines (P) in which n is a number in the range of from 0.2·m to 0.6·m, and p≧0.25·n.

In (P_{A}) and (P_{B}) preferably p=0.

The obtained polycationic polymers (P) may schematically be represented, at least for the derivatives of compounds of formula (II), by the following average formula: 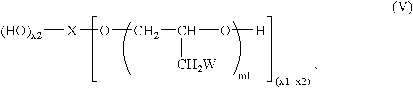
wherein

each W independently signifies the radical derived from (C) or respectively (D), at least two being (C)-derived, and two or more (C)-derived symbols W of a same molecule or of two or more different molecules form together a bridge derived from the polymerisation and optionally cross-linking reaction of (C).

By the process described above the products (P) are obtained in the form of aqueous compositions (W_{P}) which may be dispersions or solutions (e.g. also colloidal solutions) of (P).

The so produced (P)-containing aqueous compositions (W_{P}) are ready for use or may, if desired, be adjusted in (P)-content by dilution with water or evaporation or be desalinated and optionally concentrated by membrane filtration through a semipermeable membrane. They are distinguished by their stability, in particular also to storage and transportation, also under conditions of heat or frost.

The concentration of (P) in the aqueous composition (W_{P}) as produced is e.g. in the range of 5 to 60% by weight, preferably 10 to 60% by weight, more preferably 12 to 50% by weight.

If desired the produced aqueous compositions—optionally after conversion of the salt form to a basic form by suitable neutralization with a base (e.g. by addition of sodium hydroxide or potassium hydroxide)—may be dried to powders or granular products, which may, if desired or required for use, be again diluted with water and, if it is in basic form, an acid e.g. as mentioned above. Preferably, however, they are employed directly in the form of the produced aqueous concentrate compositions.

The above polymeric, optionally crosslinked etheramines (P) of the invention, optionally in the form of the mentioned aqueous compositions (W_{P}), in their protonated form are of polycationic character and are readily dilutable with water. They may be used as such, preferably in the form of the concentrated aqueous compositions (W_{P}), and may if desired be further pre-diluted e.g. to a (P)-concentration in the range of 1 to 12% by weight before addition to the treatment compositions. They serve as multifunctional polycationic adjuvants in the processing of cellulosic fibrous material, in particular in the form of loose fibres, especially in the production of paper and non-woven tissues. They serve e.g. as flocculating agents, in particular as retention and drainage aids, and as fixatives (“trash quenchers”) in the production of paper and non-woven tissues, and also as dye fixatives in the production of dyed paper and non-woven tissues.

Thus according to one feature of the invention, the polymers (P), expediently in the form of aqueous compositions (W_{P}) as produced by the method described above, serve as fixatives, for reducing the amount of backwater components, e.g. turbidity, in backwaters (white waters) from paper production.

According to a further feature of the invention, the polymers (P), expediently in the form of aqueous compositions (W_{P}) as produced by the method described above, serve as flocculating agents, drainage aids and/or retention aids in the production of paper, in particular for improving retention of size and other precipitate on the fibre (such as filling agents and other fine-size particles) and also for improving drainage speed and yield upon sheet formation.

According to a still further feature of the invention, the polymers (P), expediently in the form of aqueous compositions (W_{P}) as produced by the method described above, serve as dye fixatives in the production of dyed paper or non-woven tissues, in particular for improving fixation of dyes on the fibre.

The invention thus provides also a method for producing paper, in particular a paper web or sheet, or a non-woven tissue, from aqueous stock, wherein (P) is employed as an adjuvant, especially as a fixative, as a flocculating agent, as a drainage aid and/or retention aid and/or as a dye fixative. As “paper” there is intended herein also paper board and cast paper shapes. As an aqueous stock for the production of paper there is intended any stock, in particular cellulosic stock, as employed for papermaking and wherein the pulp suspension may derive from any origin as conventionally employed for papermaking, e.g. virgin fibre (chemical or mechanical pulp), machine broke (in particular coated broke) and reclaimed paper (especially deinked and optionally bleached reclaimed paper such as old newspaper and old cardboard). The aqueous paper pulp or stock may also contain further additions as may be desired for a certain quality, such as sizing agents, dyestuffs, optical brighteners, flocculating agents, drainage and/or retention assistants. Since the products (P) may also serve as flocculating agents, drainage and/or retention assistants, it is not necessary to employ different flocculating agents, drainage and/or retention assistants. The stock concentration may vary in any conventional range as suitable for the employed pulp, machine, process and desired paper quality, e.g. in the range of 0.4 to 10%, preferably 0.8 to 6%, by weight of dry pulp. According to a particular feature of the invention there is employed a pulp from recycled old paper or coated broke optionally blended with other pulp.

The polycationic polymers (P) of the invention are also distinguished by their compatibility with dyes and optical brighteners as conventionally employed for paper or cellulosic non-woven tissues. The invention thus provides also a method for producing dyed paper or cellulosic non-woven tissue, wherein the fibre is dyed with an anionic dye and (P)—in particular (P_{A}) or (P_{C})—is employed as an adjuvant before or after addition of the dye to the stock, in order to improve dye fixation on the substrate. As a stock for the production of tissue there is intended an aqueous stock in which the suspended fibres are of a size and quality as suitable for tissue production. As dyes there may be employed anionic dyes usually employed for dyeing paper or tissue in the stock, preferably direct dyes. As direct dyes there may be employed any such dyes as are known in the art under this designation and as defined and described in the specialised literature e.g. in the “Colour Index”. There may e.g. be employed conventional dyes, especially direct dyes, preferably of the azo- and/or metal complex series, mainly disazo dyes containing sulpho groups, preferably two or three sulpho groups, such as described e.g. in U.S. Pat. Nos. 4,083,840 and 4,833,235, or direct dyes as mentioned in the Colour Index, e.g.:
C.I. Direct Yellow 4, 6, 8, 11, 12, 27, 28, 29, 39, 44, 50, 51, 54, 55, 68, 84, 89, 98, 105, 106, 118, 127, 132, 133, 137, 148, 148:1, 150, 152, 162 and 168;
C.I. Direct Orange 15, 26, 29, 39, 40, 61, 62:1, 107 and 118;
C.I. Direct Red 9, 16, 23, 24, 26, 33, 62, 63, 79, 80, 81, 83:1, 89, 95, 111, 155, 184, 205, 207, 223, 232, 239, 253 and 261;
C.I. Direct Violet 7, 9, 35, 47, 51 and 66;
C.I. Direct Blue 1, 8, 15, 67, 71, 75, 77, 78, 80, 86, 90, 98, 106, 151, 158, 160, 173, 189, 199, 212, 218, 251, 252, 261, 262, 267 and 273;
C.I. Direct Green 26, 27, 28, 67, 68 and 69;
C.I. Direct Brown 44, 98, 103, 113, 115, 116, 170, 172, 200 and 240;
C.I. Direct Black 17, 19, 21, 22, 56, 62, 80, 91, 94, 117, 118, 123, 155 and 163;
   and mixtures of two or more thereof.

The dye may be employed at any concentrations as desired and suitable for the selected dye and substrate and for the desired effect.

The polycationic polymers (P) are preferably employed in a concentration in the range of 0.05 to 0.5% by weight, more preferably 0.1 to 0.4% by weight referred to dry substrate. There may be employed as (P) only one kind of (P) e.g. (P_{A}), (P_{B}) or (P_{C}) alone or also a mixture of two or more thereof, e.g. a mixture of (P_{A}) with (P_{B}) or (P_{C}) e.g. in the weight ratio of 10/90 to 90/10. The pH may be in the weakly basic to distinctly acidic range, preferably in the range of pH 4 to pH 8, more preferably pH 5 to pH 7. The paper or non-woven tissue may be produced using any conventional paper or tissue making machines and in a manner conventional per se. The resulting backwater is of reduced contaminants content, in particular of reduced turbidity, and consequently the respective BOD and/or COD values are also reduced.

Due to the high efficiency of (P) and especially (P_{A}) as a dye fixative, there may be achieved in particular on paper and tissue very regular and level dyeings, from very light to very deep and intense shades as desired, in high yield and brilliance and of optimum fastnesses, while the dyeing time—i.e. the time interval between addition of the dye to the pulp suspension and sheet formation (P) or (P_{A}) being added to the pulp suspension either before addition of the dye or after addition of the dye—may be as conventional per se for the employed dye, e.g. one hour or less, and, by the use of the dye fixative of the invention, may also be reduced to a minimum. There may be achieved dyeings that are substantially free of undesired appearances such as two-sidedness and mottleness, even if there are employed mixtures of compatible dyes as conventionally employed for colour-matching.

By the use of (P) there may also be achieved an improvement of the efficiency of other cationic wet-end additives such as wet strength agents, and there may be obtained paper of optimum quality and colour shade and yield and fastnesses of the dyeings, while paper breakings due to disturbing anionic contaminants is correspondingly reduced.

Wet strength agents may be added after (P) has fixed the dye.

While the products (P) may be used as all-round agents for flocculation, drainage, retention, trash-quenching and dye fixation, some of the polymers may be preferred with a view to a preferred or main purpose of use. Thus polymers (P_{A}) are particularly preferred as dye fixatives, and polymers (P_{B}) are particularly preferred for flocculation, drainage, retention and trash-quenching, while polymers (P_{C}) are preferably used as all-round agents.

In the following Examples parts and percentages are by weight, if not otherwise indicated; parts by weight relate to parts by volume as grams to millilitres. The temperatures are indicated in degrees Celsius. The employed water is demineralised water.

### EXAMPLE 1

(a) Production of a chlorohydrin (E1) from glycerol

92 g of glycerol are placed in a 700 ml flange flask and heated to 80° C. 0.1 g of boron trifluoride acetic acid complex are added and 277.5 g of epichlorohydrin are added dropwise over one hour at 80° C. with cooling. When the addition is complete the reaction mixture is cooled to 20° C.

(b) Production of a polymer (P1) and Composition (W_{P1})

100 g of the chlorohydrin produced in part (a) are placed in a 700 ml flange flask and 80 g of water are added. The mixture is stirred and 50.7 g of diethylenetriamine are added slowly over 2 hours keeping the temperature at 50° C. The reaction mixture is then warmed to 60° C. and held at this temperature for two hours, and the mixture slowly thickens as it polymerises. The mixture is then diluted with 235.6 g of water and heated back to 60° C. It is maintained for about one further hour at this temperature until a viscosity of 500-1500 cP at 20° C. is achieved. 36 g of aqueous 85% formic acid are then added and the product is cooled to ambient temperature to give 502.3 g of Composition (W_{P1}) with 30% active substance (P1) content. The measured cationic charge is 3.9 meq/g referred to the dry substance, at pH 4.

### EXAMPLE 2

The procedure described in Example 1 is repeated, with the difference that in part (b) instead of 50.7 g of diethylenetriamine there are employed 52.5 g of triethylenetetramine and after polymerisation 274.1 g of water are added instead of 235.6 g to give a Composition (W_{P2}) with 30% active substance (P2) content. The measured cationic charge is 3.3 meq/g referred to the dry substance, at pH 4.

### EXAMPLE 3

The procedure described in Example 2 is repeated, with the difference that in part (b) instead of 52.5 g of triethylenetetramine there are employed 73.4 g thereof and after polymerisation 253.2 g of water are added instead of 274.1 g and 40 g of the 85% formic acid are added instead of 36 g to give a Composition (W_{P3}) with 30% active substance (P3) content.

### EXAMPLE 4

The procedure described in Example 2 is repeated; with the difference that in part (b) instead of 52.5 g of triethylenetetramine there are employed 70 g of diethylenetriamine and after polymerisation 271.6 g of water are added instead of 274.1 g and 46 g of the 85% formic acid are added instead of 36 g to set a pH of 4 and to give a Composition (W_{P4}) with 30% active substance (P4) content. The measured cationic charge is 5.03 meq/g referred to the dry substance, at pH 4.

### EXAMPLE 5

150 g of chlorohydrin (E1) produced in Example 1 part (a) and 50 g of water are mixed and stirred. A mixture of 31.2 g of diethylenetriamine and 31.5 g of dimethylaminopropylamine is added at 60° C. over one hour. 194.4 g of water are added slowly at 60° C. as the reaction mixture thickens. After two hours the reaction mixture is cooled to room temperature and 151.4 g of an aqueous 32% sodium hydroxide solution is added and the mixture is kept at 30° C. for a further hour until a viscosity of 500-1500 cP is achieved. The reaction is then stopped by addition of 100.5 g of 85% formic acid to give a Composition (W_{P5}) with 30% active substance (P5) content. The measured cationic charge is 4.1 meq/g referred to the dry substance, at pH 4.

### EXAMPLE 6

150 g of chlorohydrin (E1) produced in Example 1 part (a) and 50 g of water are mixed and stirred. A mixture of 62.5 g of diethylenetriamine and 12.5 g of dimethylaminopropylamine is added at 60° C. over one hour. 220 g of water are added slowly at 60° C. as the reaction mixture thickens. After two hours the reaction mixture is cooled to room temperature and 151.4 g of an aqueous 32% sodium hydroxide solution is added and the mixture is kept at 30° C. for a further hour until a viscosity of 500-1500 cP is achieved. The reaction is then stopped by addition of 103.6 g of 85% formic acid to set a pH of 4 and to give a Composition (W_{P6}) with 30% active substance (P6) content.

### EXAMPLE 7

100 g of the chlorohydrin produced in part (a) of Example 1 are stirred with 80 g of water and 50.7 g of diethylenetriamine are added dropwise over 2 hours keeping the temperature at 50° C. The reaction mixture is then warmed to 60° C. and held at this temperature for two hours, and the mixture slowly thickens as it polymerises. The mixture is then diluted with 235.6 g of water and heated back to 60° C. It is maintained for about one further hour at this temperature and 100 g of water are then added. The mixture is held for a further hour at 60° C. and then 151.2 g of water are added and the mixture is held at 600 for about 1 hour, until a viscosity of 500-1500 cP at 20° C. is achieved. 36 g of aqueous 85% formic acid are then added and the product is cooled to ambient temperature to give 753.5 g of Composition (W_{P7}) with 20% active substance (P1) content. The product is a clear pale yellow viscous liquid of pH 4. The measured cationic charge is 3.9 meq/g referred to the dry substance, at pH 4.

### EXAMPLES 8-11

The procedure described in Examples 1(b), 2, 3 and 4 is repeated, with the difference that, instead of 100 g of chlorohydrin (E1) of Example 1 part (a), there are employed 100 g of chlorohydrin (E8) produced as follows:

54.7 g of glycerol are placed in a 500 ml flange flask and heated to 80° C. 0.5 g of boron trifluoride acetic acid complex are added followed by 10 g of epichlorohydrin. 134.4 g of epichlorohydrin are added dropwise over two hours at 80° C. with cooling. When the addition is complete the reaction mixture is cooled to 20° C.

### EXAMPLE 12

200 g of the chlorohydrin (E8) produced as described in Example 8 are placed in a 3 l flange flask and 160 g of water are added. The mixture is stirred and 100 g of diethylenetriamine are added slowly over 2 hours keeping the temperature at 50° C. 170 g of water are added and the reaction mixture is warmed to 85° C. and held at this temperature for two hours, and the mixture slowly thickens as it polymerises. When a viscosity of 2000 cP at 23° C. is achieved, 299 g of water are added, followed by 72 g of aqueous 85% formic acid and the product is cooled to ambient temperature to give 1000.6 g of Composition (W_{P12}) with 30% active substance (P12) content. The measured cationic charge is 3.9 meq/g referred to the dry substance, at pH 4.

### EXAMPLE 13

(a) Production of a Chlorohydrin (E13) From Glycerol

149.2 g of glycerol are placed in a 1 l flange flask and heated to 80° C. 0.5 g of boron trifluoride acetic acid complex are added followed by 20 g of epichlorohydrin. 405.6 g of epichlorohydrin are added dropwise over one hour and 40 minutes at 80° C. controlling the exotherm with cooling. When the addition is complete a further 15 g of epichlorohydrin are added and then the reaction mixture is cooled to 20° C.

(b) Production of a Polymer (P13) and Composition (W_{P13})

100 g of chlorohydrin (E13) produced in part (a) are placed in a 1 l flange flask and a solution of 47.1 g of hexamethylene diamine in 80 g of water are added followed by 100 further g of water. The reaction mixture is then warmed to 70° C. and held at this temperature for 50 minutes, and the mixture slowly thickens as it polymerises. The mixture is then diluted with 148.2 g of water and heated back to 60° C. Stirring is continued for 5 minutes adiabatically until a viscosity of 500-1500 cP at 20° C. is achieved. 15 g of aqueous 85% formic acid are then added and the product is cooled to ambient temperature to give 490.3 g of Composition (W_{P13}) with 30% active substance (P13) content. The measured cationic charge is 5 meq/g referred to the dry substance, at pH 4.

### EXAMPLE 14

(a) Production of a Chlorohydrin (E14) From Glycerol

596.4 g of glycerol are placed in a 3 1 flange flask and heated to 80° C. 3 g of boron trifluoride acetic acid complex are added followed by 50 g of epichlorohydrin. 1568 g of epichlorohydrin are added dropwise over 3 hours and at 80° C. controlling the exotherm with cooling. When the addition is complete a further 40 g of epichlorohydrin are added and the reaction mixture is cooled to 20° C.

(b) Production of a Polymer (P14) and Composition (W_{P14})

100 g of chlorohydrin (E14) produced in part (a) are placed in a 1 l flange flask and a solution of 50 g of hexamethylene diamine and 20 g of diethylenetriamine in 80 g of water are added slowly at 50° C. over 2 hours and 35 minutes. The reaction mixture is warmed to 70° C. and held at this temperature for two hours, and then warmed to 80° C. and held at this temperature for three and a half hours the mixture slowly thickens as it polymerises. The mixture is then diluted with 281 g of water and heated back to 68° C. It is maintained for about 5 minutes at this temperature until a viscosity of 500-1500 cP at 20° C. is achieved. 36 g of aqueous 85% formic acid are then added and the product is cooled to ambient temperature to give 567 g of Composition (W_{P14}) with 30% active substance (P14) content. The measured cationic charge is 5.2 meq/g referred to the dry substance, at pH 4.

### EXAMPLE 15

(a) Production of a Chlorohydrin (E15) From Glycerol and Sorbitol

100 g of sorbitol and 50.6 g of glycerol are placed in a 700 ml flange flask and heated to 80° C. 0.5 g of boron trifluoride acetic acid complex are added followed by 20 g of epichlorohydrin. 268 g of epichlorohydrin are added dropwise over 2 hours and at 80° C. controlling the exotherm by adjusting the flow of epichlorohydrin. When the addition is complete a further 15 g of epichlorohydrin are added and then the reaction mixture is cooled to 20° C.

(b) Production of a Polymer (P15) and Composition (W_{P15})

113 g of chlorohydrin (E15) produced in part (a) are placed in a 700 ml flange flask, 80 g of water are added and the mixture is heated to 50° C. 50.7 g of diethylenetriamine are added slowly at 50° C. over 2 hours. The reaction mixture is warmed to 60° C. and held at this temperature for one hour, the mixture slowly thickens as it polymerises. The mixture is then diluted with 265 g of water and heated back to 51° C. It is maintained for about 5 minutes at this temperature until a viscosity of 500-1500 cP at 20° C. is achieved. 36 g of aqueous 85% formic acid are then added and the product is cooled to ambient temperature to give 265 g of Composition (W_{P15}) with 30% active substance (P15) content.

### Application Example A

100 ml of pulp are measured into a beaker and stirred at 500 rpm. The pulp is filtered through a Whatman No. 54 paper and the filtrates are retained. The COD of the filtrates is measured using standard procedures as set out by the spectrophotometer being used (Hach or Dr. Lange). Similarly the turbidity is measured using a spectrophotometer. The above procedure is repeated but this time the pulp is dosed with the cationic polymer (P3) of Example 3 added in the form of (W_{P3}) at levels equivalent to 1, 2, 3 and 4 kg/t of (P3) related to dry pulp, before filtration. The COD and turbidity of the filtrates are measured and compared with the blank test. There are obtained improved values.

### Application Example B

A coated broke pulp is prepared at 3%. The coated broke is pulped for 3 minutes in a laboratory blender and then for 20 minutes in a laboratory disintegrator.

100 ml of coated broke pulp of 3% consistency is stirred for 40 seconds at 300 rpm and then it is filtered through a Whatman 54 filter paper under constant vacuum. Further 100 ml pulp samples are treated with product (P3) of Example 3 added in the form of (W_{P3}) at dose rates of 0.5, 1.0 and 1.5 kg/t of product (P3) related to dry pulp, as follows: The pulp is stirred for 10 seconds, then the required amount of product (P3) is added and the mixture is stirred for further 30 seconds before filtering. The turbidity is measured using a spectrophotometer and indicates for the samples treated with (P3) improved values for turbidity reduction in comparison with the blank.

### Application Example C

1 litre of stock (50% old newspaper, 50% old corrugated cardboard) at a consistency of 1.00% is placed in a measuring cylinder and mixed by inverting the cylinder four times. After mixing, the stock is poured into a modified Shopper-Riegler Freeness Tester (rear outlet blocked) and the plunger is released whilst the stopwatch is started. The time for a fixed volume of “backwater” to drain is recorded. This is done to establish a “blank time” for the stock used. The test is repeated with the required amount of the product (P3) of Example 3 added in the form of (W_{P3}) [2, 4 and 6 kg/t referred to dry product (P3) related to dry substrate] added just before the mixing stage. The stock is then placed in a freeness tester and the time for same volume of water to drain is recorded. The COD and turbidity of the filtrates are also measured and compared with the blank test. There are obtained improved values for draining time, COD and turbidity reduction.

Analogously as the product (P3) of Example 3, the products (P4), (P5), (P6), (P10) and (P11) of Examples 4, 5, 6, 10 and 11 are employed in the form of Compositions (W_{P4}), (W_{P5}), (W_{P6}), (W_{P10}) and (W_{P11}) in Application Examples A, B and C, giving also improved results.

### Application Example D

A 50:50 bleached softwood/hardwood unsized stock is prepared at 2.5% consistency. The Shopper Riegler value of the stock is adjusted to 30°SR. 200 ml pulp samples are placed into 1 litre dye pots and the pots are placed underneath running stirrers at 800 rpm. d % of the red dye of Example 1 of U.S. Pat. No. 4,083,840 (optionally in the form of a composition according to Example 82, 84 or 85 of U.S. Pat. No. 4,083,840) is added and the stopwatch is simultaneously started. After 3.5 minutes f % of the product (P1) of Example 1 is added in the form of (W_{P1}) as a dye fixative and stirring is continued for another 1.5 minutes. After this time the stirrer is switched off and the fibres are diluted to 1 litre with water. A sheet former is placed in a sink filled with water. The dilute fibres are quickly stirred, poured into the sheet former and water is immediately drained from the sink. Any water present draining from the sheet after this time is collected as backwater. The sheets are placed into blotters between damp felts between PVC plates. These are pressed at 10 t/m² for 2 minutes and the sheets are dried for 10 minutes at 96° C. The backwater colour is visually rated and the brightness and shade of the finished sheets is compared to the dyed sheet without any fixative by instrumental measurement (Elrepho). For the dyeing obtained using the product (P1) of Example 1 there are obtained improved values. The concentrations d % are 0.08, 0.25 and 0.66% referred to dry pulp, and the concentrations f % referred to dry product (P1) related to dry pulp are 0.15% for d=0.08, 0.46% for d=0.25, and 1.2% for d=0.66.

### Application Example E

The procedure described in Application Example D is repeated with the difference that the sequence of the additions of dye and fixative is inverted.

Analogously as the product (P1) of Example 1, the products (P2), (P5), (P6), (P7), (P8), (P9), (P12), (P13), (P14) and (P15) of Examples 2, 5, 6, 7, 8, 9, 12, 13, 14 and 15 are employed in the form of their Compositions (W_{P2}), (W_{P5}), (W_{P6}), (W_{P7}), (W_{P8}), (W_{P9}), (W_{P12}), (W_{P13}), (W_{P14}) and (W_{P15}) in Application Examples D and E, giving also improved results.

1. A polymeric etheramine (P) obtainable by reaction of
(A) an oligohydroxycompound which is an oligohydroxyalkane of molecular weight ≧92 and with x hydroxygroups, wherein x is a number in the range of 3 to 6,
or a mixture of two or more thereof,
or a mixture of one or more thereof with at least one alkanediol containing 2 to 4 carbon atoms,
with
(B) epichlorohydrin,
in the ratio of more than two moles of (B) per mole of (A) and on average not more than 1.2 molecules of (B) per hydroxygroup of (A),
to give a chloro-terminated adduct (E),
and exhaustive reaction of (E) with
(C) at least one aliphatic oligoamine containing at least one primary amino group and
at least one further amino group which is primary or secondary,
in the molar ratio of n moles of (C) for every mole of (E), wherein n is >1 and smaller than the number of linked chlorine atoms in (E) present on average per molecule of (E),
and optionally
(D) at least one aliphatic mono- or diamine containing only one primary or secondary amino group any further amino group being tertiary,
in the molar ratio of p moles of (D) for every mole of (E), wherein p is sufficient for reacting any available chlorine of (E) not reacted with (C),
in such a ratio of [(C)+(D)] to (E) that the total number t of basic amino groups in [(C)+(D)] is higher than the total number of linked chlorine atoms in (E),
and which is optionally protonated.

2. A polymeric etheramine (P) according to claim 1, wherein the ratio of (B) to (A) is of m moles of epichlorohydrin for every mole of oligohydroxycompound (A), in which m is >2 and at most 1.2·x, the ratio n of (C) to (E) is >1 and <m, and the ratio p of (D) to (E) is ≧0 and <(m−n).

3. A polymeric etheramine (P) according to claim 1 or 2, wherein (C) is
(C₁) at least one oligoamine of formula 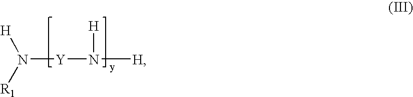
wherein
R₁ signifies hydrogen or C₁₋₃-alkyl,
y signifies a number from 1 to 3
and
Y signifies C₂₋₃-alkylene, if y is 2 to 3,
or signifies C₂₋₄-alkylene, if y is 1.

4. An aqueous composition (W_{P}) comprising a protonated, polymeric, optionally crosslinked etheramine (P) according to any one of claims 1 to 3.

5. A process for the production of a polymeric optionally protonated etheramine (P) according to any one of claims 1 to 3, optionally in the form of an aqueous composition (W_{P}) according to claim 4, wherein the chloroterminated reaction product (B) of (A) with (B) is reacted in aqueous medium with (C) and optionally (D) and the product is optionally protonated, and if desired the obtained aqueous composition is dried.

6. Use of a polymeric crosslinked optionally protonated etheramine (P) according to any one of claims 1 to 3, optionally in the form of an aqueous preparation (W_{P}) according to claim 4, as an adjuvant in the processing of cellulosic fibrous material.

7. Use of (P) according to claim 6 as an adjuvant in the production of paper or non-woven tissues.

8. Use of (P) according to claim 6 or 7 as a fixative for water soluble anionic dyes or optical brighteners.

9. Use of (P) according to claim 6 or 7 as a retention aid or drainage aid or as a trash quencher in the production of paper.

10. Use according to claim 8 in the production of dyed paper, wherein the fibre is treated with (P) before or/and after addition of the dye, in the stock.

11. Use according to claim 10, wherein (P) is added to the paper stock.
